(19) United States
(12) Patent Application Publication
(10) Pub. No.: US 2020/0352314 A1
(43) Pub. Date: Nov. 12, 2020

(54) TOOTHBRUSH

(71) Applicant: Alessio BATTAGLIA, Bologna (IT)

(72) Inventor: Alessio BATTAGLIA, Bologna (IT)

(21) Appl. No.: 16/937,127

(22) Filed: Jul. 23, 2020

Related U.S. Application Data
(62) Division of application No. 12/067,656, filed on Apr. 1, 2008.

(30) Foreign Application Priority Data
Sep. 21, 2005 (IT) BO2005A000571

(51) Int. Cl. A46B 5/02; A46B 13/02; A46B 9/04; A61C 17/26

(52) U.S. Cl. CPC A46B 5/02; A46B 13/02; A46B 2200/1066; A61C 17/26; A46B 9/04

(57) ABSTRACT

A toothbrush includes a handle, a head mounting bristles and a connecting portion. The handle and the connecting portion extend from the head in the direction opposite to the direction of the bristles. The toothbrush also includes a connector which allows the head to be changed. An alternative embodiment of the toothbrush comprises a roller having bristles and being rotatably mounted on the head, an electric motor and transmission means that connect the motor to the roller.

### TECHNICAL FIELD

This invention relates to a brush for cleaning the teeth.

### BACKGROUND ART

It is known that toothbrushes currently in use consist of a handle joined to a head by a connecting portion. The head has a plurality of bristles, usually parallel to each other and positioned perpendicularly to a flat surface of the head. Traditionally, the head, the connecting portion and the handle are positioned along a single straight line and the bristles are perpendicular to the line. The straight line is also the axis about which the toothbrush has to be turned when cleaning the teeth. The working range of the bristles is thus defined by the arc described by the ends of the bristles as they turn about the axis.

Also known are toothbrushes with a handle, a head, a plurality of bristles attached to a surface of the head and a connecting portion between the handle and the head, where the connecting portion is such that it extends from the head in the same direction as the handle and the bristles.

Disadvantageously, toothbrushes made in this way have limited access to the oral cavity and, to enable the surface defined by the free ends of the bristles to come into effective contact with the surface of the teeth, must be held at an unnatural angle by the user. This makes it difficult to reach all parts of the oral cavity which means that the surface defined by the free ends of the bristles cannot effectively brush all tooth surfaces and gum margins. Dental hygiene is thus appreciably reduced.

Moreover, this arrangement limits the working range of the bristles obliging the user to make excessive and awkward twisting movements of the wrist.

### DISCLOSURE OF THE INVENTION

This invention therefore provides a toothbrush, as described in claim 1, with a handle, a head and a plurality of bristles attached to a surface of the head and forming a toothbrush working line; the toothbrush is characterised in that it has a connecting portion located between the handle and the head; and in that the handle and the connecting portion extend from the head in a direction opposite to that of the bristles defining the working line.

The toothbrush according to the invention thus makes cleaning the teeth easier and more effective.

Other advantageous characteristics of the invention are described in the other claims.

### BRIEF DESCRIPTION OF THE DRAWINGS

The technical characteristics and advantages of the invention will become more apparent from the detailed description which follows, with reference to the accompanying drawings which illustrate preferred, non-limiting embodiments of the invention, and in which:

FIG. 1 is a side view of a first embodiment of the toothbrush according to the invention;

FIG. 2 is a side view of a second embodiment of the toothbrush;

FIG. 3 is a side view of a detail of a third embodiment of the toothbrush similar in other respects to the embodiment shown in FIG. 1;

FIG. 4 is a side view of a detail of the handle of the toothbrush of FIG. 1;

FIG. 5 is a plan view of the detail of FIG. 4;

FIG. 6 is a side view of a fourth embodiment of the toothbrush according to the invention;

FIG. 7 is a perspective view of a tongue protecting element that can be associated with the toothbrush of FIG. 6;

FIG. 8 is a side view of a fifth embodiment of the toothbrush according to the invention;

FIG. 9 is a perspective view of a sixth embodiment of the toothbrush according to the invention;

FIG. 10 is a side view of the sixth embodiment of the toothbrush according to the invention;

FIG. 11 is a plan view from below of the sixth embodiment of the toothbrush according to the invention;

FIG. 12 is a plan view from above of the sixth embodiment of the toothbrush according to the invention;

FIG. 13 is a perspective view of a seventh embodiment of the toothbrush according to the invention;

FIG. 14 is a schematic side view of a detail of an eighth embodiment of the toothbrush according to the invention;

FIG. 15 is a plan view from above of a preferred embodiment of a head applicable to any of the toothbrushes according to the invention;

FIGS. 16A, 16B, 16C are front views of different embodiments of the head applicable to any of the toothbrushes according to the invention;

FIG. 17 is a side view of a second power-driven embodiment of the toothbrush according to the invention;

FIG. 18 is a plan view from below of the second power-driven embodiment of the toothbrush according to the invention in a first operating condition;

FIG. 19 is a plan view from below of the second power-driven embodiment of the toothbrush according to the invention in a second operating condition.

### DETAILED DESCRIPTION OF THE PREFERRED EMBODIMENTS OF THE INVENTION

With reference to the accompanying drawings, the numeral 1 denotes in its entirety a toothbrush comprising a handle 2, a connecting portion 3 connected to the handle 2, and a head 4 connected to the connecting portion 3. The head 4 comprises a plurality of bristles 5 which, preferably, as illustrated, extend in directions parallel to each other from a surface or face 4a of the head 4.

Specifically, the free ends 5a of the bristles 5 form a working line L of the toothbrush 1.

The working line defined by the ends of the bristles may form a flat working surface, as illustrated, or a working surface that is curved in a transversal direction, as described and illustrated below. More specifically, the curved shape of the working surface may be formed either by bristles extending radially from the head or by bristles extending in parallel directions but differing in length so that the ends of the bristles together form a curved surface.

Advantageously, as illustrated, the handle 2 and the connecting portion 3 extend from the head 4 in the opposite direction to that of the bristles 5 so that the head 4, having a mounting plate for the bristles 5, is spaced from the handle 2 in the direction of bristle 5 extension, thereby allowing the connecting portion 3 to be suitably angled. Thus, the toothbrush requires less effort of the user because the bristles 5 can make extended sweeping movements without the user having to twist his or her wrist excessively.

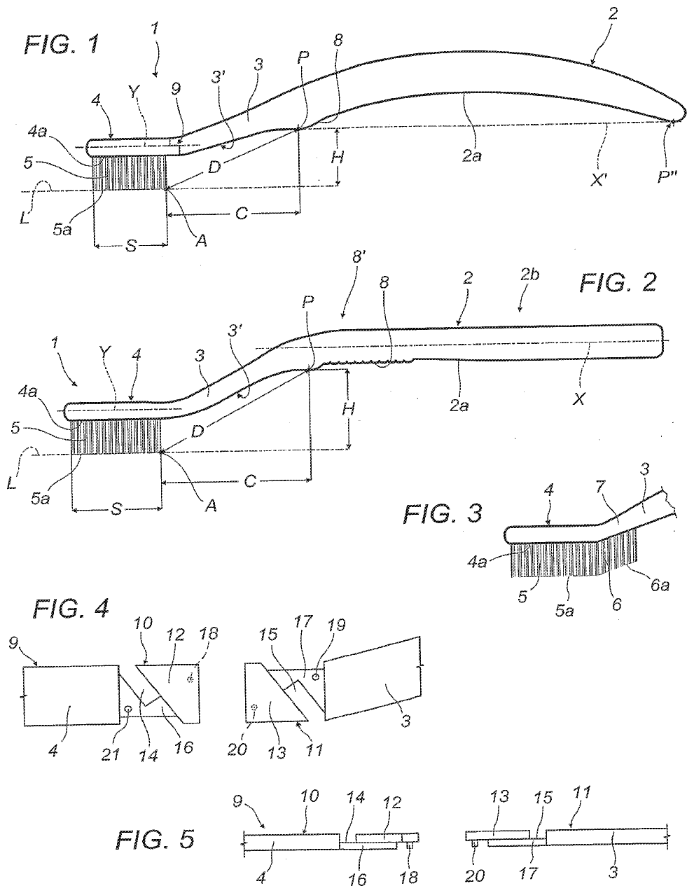

The handle may have any shape. Advantageously, however, the handle 2 has a curved ergonomic shape, as illustrated in FIG. 1, with the concave part facing the working line L and with the ends P e P″ of the part gripped by the user aligned along an imaginary line or longitudinal axis X′ that is substantially parallel to the working line L (FIG. 1).

The handle 2 may also be straight, extending along a longitudinal axis X that is substantially parallel to the working line L (FIG. 2).

A working surface that is concave or convex in the transversal direction, as illustrated in FIGS. 16A and 16B, can be formed by parallel bristles arranged in longitudinal rows, where the bristles in each longitudinal row are the same in height as the other bristles in that row but different in height from the bristles in the other rows.

According to another aspect, the toothbrush head comprises a respective toothbrush bristle mounting body 4 having a principal longitudinal axis of extension (Y) passing through the centre of the transversal sections of the mounting body and defining the axis of the head which extends preferably in a direction parallel or substantially parallel to the principal longitudinal axis (X or X′) of the handle (2).

Advantageously, the connecting portion 3 extends in a linear or substantially linear direction and has a linear or substantially linear upper surface 3′, that is to say, the face of it on the same side or in the same direction as the bristles 5 is linear or substantially linear. This reduces the risk of engaging the incisors while cleaning the molars. According to another advantageous aspect, the surface 3′ might be concave in the direction in which the bristles 5 extend, that is to say, it would have a recessed configuration compared to the surface 3′ illustrated in FIGS. 1 and 2.

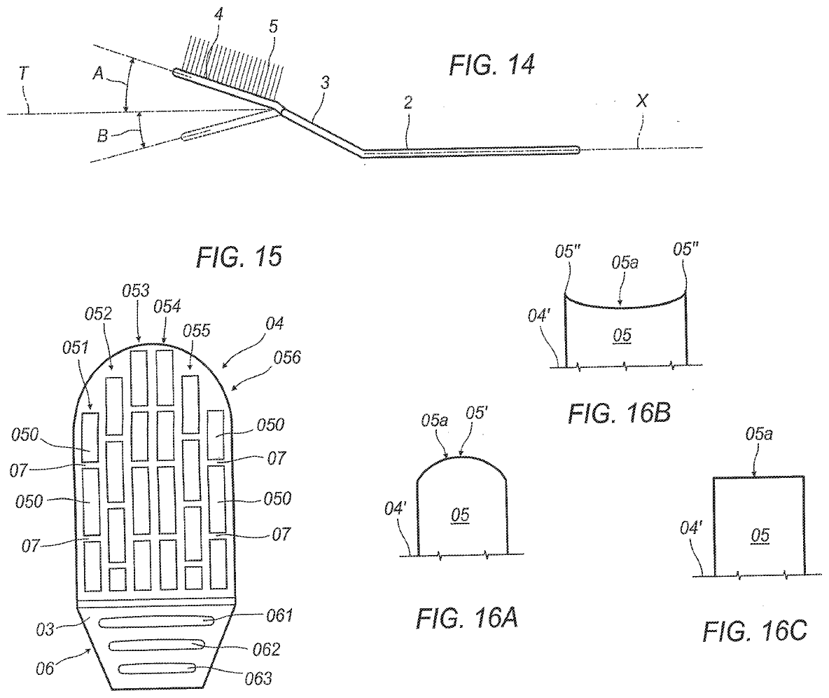

FIG. 14 shows how the head 4 might also be inclined upwards at an angle A or downwards at an angle B (as shown by the dashed line) with respect to an imaginary line T in the direction of principal extension of the head and parallel longitudinal axis X of the handle. The angles A and B made with the line T parallel to the handle are preferably less than or equal to 15°.

In another embodiment, auxiliary bristles 6 are applied also to a limited area 7 of the connecting portion 3 (FIG. 3). The area 7 is located in the vicinity of the join between the connecting portion 3 and the head 4. Preferably, as illustrated, the auxiliary bristles 6 are parallel to and oriented in the same direction as the bristles 5, and are also preferably equal in height.

Thus, at the connecting portion 3, the auxiliary bristles 6, form a working surface 6a that extends at an angle to the working surface 5a formed by the primary bristles and, in the direction of the handle 3, the working surface 6a remains parallel to the connecting portion 3.

This arrangement of the bristles 6 on the connecting portion 3 makes it easier to effectively brush the lingual or inside part of the incisors. In particular, it is possible to clean the top and bottom lingual parts or, more specifically, the lingual walls of the teeth 45, 44, 43, 42, 41, 31, 32, 33, 34, 35, and the palatal walls of the teeth 15, 14, 13, 12, 11, 21, 22, 23, 24, 25, (that is to say, from the 2nd premolar on the right to the 2nd premolar on the left in the top and bottom jaws). These numeric designations relating to the teeth are well within the knowledge of a dental specialist and, for brevity and convenience, will not be explained in detail.

The bristles 6 might, however, also be oriented in a direction perpendicular to the surface of the connecting portion. Other orientations of the bristles 6 are also imaginable.

Further, on the side 2a of the handle 2 facing the bristles 5, there is a finger rest 8 for manipulating the handle and designed to receive the user's thumb or index finger, depending on which part of the oral cavity is being brushed. This finger rest 8 is located near a point P where the handle 2 joins the connecting portion 3.

The free ends 5a of the bristles nearest the finger rest 8 define a point A.

It is thus possible to define the distance D between the points P and A and the height H separating the point P from the working line L of the toothbrush 1. Similarly, the reference character C denotes the distance separating the point P, as projected onto the working line L, from the point A.

To improve the accessibility properties of the toothbrush, five different embodiments are provided to suit different user characteristics, as described in more detail below. These embodiments differ in terms of distance D and height H.

As a whole, the distance D may vary in a range of 4 cm to 7 cm and, preferably, 4.6 cm to 5.8 cm, whilst the height H may vary in a range of 1.7 cm to 3.5 cm and, preferably, 1.7 cm to 2.8 cm. Therefore, the distance C may vary in a range of 3.5 cm to 6.0 cm and, preferably, 4.3 cm to 5.0 cm.

Further, the length S of the bristled portion of the toothbrush, that is to say, of the working surface of the bristles, varies in a range of 1.0 cm to 3.0 cm and, preferably, 1.8 cm to 2.3 cm.

As to the height of the bristles, that is to say, the distance between the working surface 5a, and the head surface 4a from which the bristles extend, this may vary in a range of 0.5 cm to 1.5 cm, and, preferably, varies in a range of 0.7 cm to 1.3 cm.

Specifically, in an embodiment designed for a standard adult user, the distance D measures 5.5 cm and the height H 2.2 cm. The distance C measures 5.0 cm.

In another embodiment designed for users with low teeth or gum hypertrophy, the distance D measures 5.4 cm and the height H 1.7 cm. The distance C measures 5.2 cm.

In an embodiment designed for users with large mouths or teeth that are excessively inclined in a vestibular, palatal or lingual direction, or, more specifically, with pronounced lower incisors and wide, ogival palates, the distance D measures 5.8 cm and the height H 2.8 cm. The distance C measures 5.0 cm.

In yet another embodiment designed for children, the distance D measures 4.6 cm and the height H 1.7 cm. The distance C measures 4.3 cm.

Finally, in an embodiment designed for adult users with small mouths, the distance D measures 4.8 cm and the height H 2.2 cm. The distance C measures 4.3 cm.

The above measurements relate to the optimum configurations for the respective user types and the values of D, H and C indicated may vary by plus or minus 2 or 3 mm and, preferably, the values of D, H and C indicated, especially the values of H indicated, may vary by plus or minus 1 mm.

As illustrated in FIG. 2, the invention also contemplates the provision of another finger rest 8′, constituting a surface or means for engaging or resting one of the user's other fingers, on the side of the handle opposite that where the finger rest or surface 8 is located, said finger rest 8′ being similar in all respects to the finger rest 8.

In this way, the user is encouraged to grip the toothbrush in one of the two most recommended ways, in particular, when the Bass brushing method is used, obtaining an optimum application of this method for various users, this Bass method being well known in the dental sector and, for brevity and convenience, not described in detail in this specification.

In particular, according to the Bass brushing method, considering the example of a right-handed user, when the user's thumb is placed on the finger rest 8 on the side 2a and, consequently, the user's index finger is placed on the finger rest 8′ on the side 2b, the free surface of the bristles is set to brush the left-hand side of the teeth and, more specifically, the vestibular surfaces of the 2nd and 3rd quadrants and the lingual surfaces of the 1st and 4th quadrants, as well as the occlusal surfaces of the lower jaw. On the other hand, to brush the lingual surfaces of the 2nd and 3rd quadrants, the vestibular surfaces of the 1st and 4th quadrants and the occlusal surfaces of the upper jaw, the user's index finger is placed on the finger rest 8 on the side 2a and, consequently, the thumb on the finger rest 8′ (side 2b). A left-handed user holds the handle in the same way when brushing the occlusal surfaces but the other way round when brushing the other tooth surfaces mentioned above. These designations relating to the teeth are well within the knowledge of a dental specialist and, for brevity and convenience, will not be explained in detail.

According to another advantageous aspect, all the embodiments described above might have a connector, not illustrated, located between the connecting portion 3 and the handle. This connector would enable the user to choose the connecting portion and toothbrush head of the size best suited to the characteristics of his or her mouth.

In another embodiment, a connector 9 is provided between the head 4 and the connecting portion 3 (FIGS. 4 and 5). The connector 9 enables the toothbrush head 4 to be changed when worn. Further, to avoid damage to the interior of the user's mouth, the connector might be designed in such a way as to become loose, without being disconnected altogether, if the user applies too much pressure on the toothbrush 1.

Whatever the case, the connector 9 consists of a first hook 10 fixedly connected to one end of the head 4 and a second hook 11 connected to one end of the connecting portion 3. The hooks 10, 11 have matching shapes and are designed to slot into each other.

Thus, each hook 10, 11 consists of a suitably shaped plate 12, 13 and a respective slot 14, 15 shaped to match the plate 12, 13.

The plates 12, 13 of the first hook 10 and of the second hook 11 are connected to the head 4 and to the connecting portion 3 of the toothbrush 1 by a first and a second protrusion 16 and 17, respectively. The protrusions 16, 17 are shaped in such a way that, when hooked, they are positioned side by side on the same surface, without interfering with each other.

During the hooking action, the plate 12 of the first hook 10 is positioned inside the slot 15 of the second hook 11, while the plate 13 of the second hook 11 is positioned inside the slot 14 of the first hook 10. The dimensions of the plates 12, 13 and of the slots 14, 15 are such as to allow a reciprocal fit with the minimum interference to guarantee a secure hold of the connector 9.

There may also be at least one first pin 18 on the plate 12 of the first hook 10 designed to fit into a first hole 19 made in the second protrusion 17 on the second hook 11. The coupling between the first pin 18 and the first hole 19 further strengthens the connector 9.

If necessary, there may also be a second pin 20 on the plate 13 of the second hook 11 designed to fit into a second hole 21 made in the first protrusion 16 on the first hook 10.

The technical characteristics of the toothbrush according to the invention facilitate accessibility to the user's oral cavity.

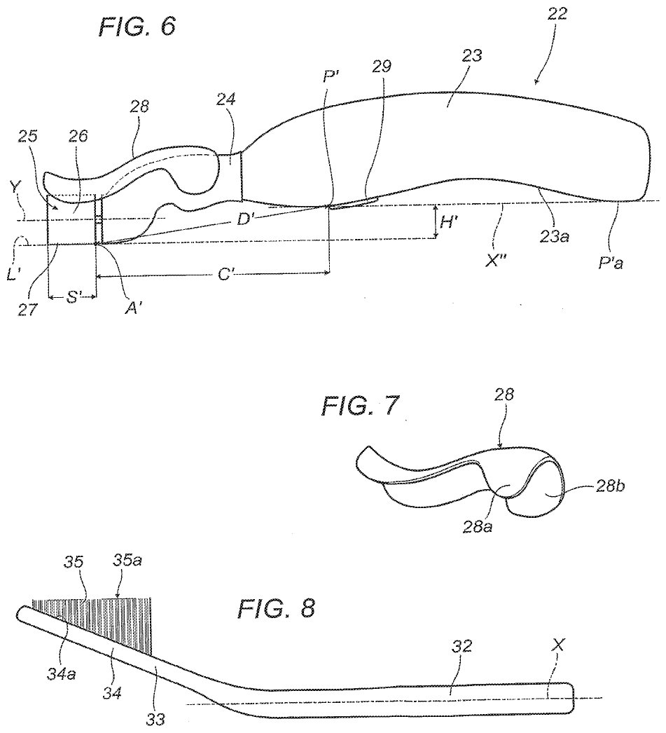

FIG. 6 illustrates an electric toothbrush 22 comprising a handle 23 joined by a connecting portion 24 to a head 25.

The free end of the head 25 is connected to a roller 26 that is rotatable about a longitudinal axis Y and associated with suitable motor means, not illustrated. The roller 26 mounts a plurality of bristles 27 arranged radially on its lateral surface in such a way that the bristles are perpendicular to the lateral surface of the roller 26.

The roller 26 is positioned in such a way that the bristles 27 define a working line L′ lying on the side of the roller 26 longitudinal axis Y opposite the handle 23 and opposite the connecting portion 24.

Advantageously, as illustrated, the axis of rotation Y of the roller extends in a direction substantially parallel to the handle 23. Thus, the handle 23 may be held in such a way that the ends P′ and P′ a are engaged by the user's hand along an imaginary line X″ that is substantially parallel to the working line L′ or to the axis of rotation Y.

Advantageously, the bristle portion located on the opposite side of the working line L′ is covered by a cap 28 which prevents the bristles 27 from coming into contact with the parts of the oral cavity that are not teeth.

The cap 28 is removably associated with the toothbrush so that it can be detached from the roller 26, allowing access to the latter for example when it needs to be removed.

In one embodiment of it, illustrated in FIG. 7, the tongue protecting cap 28 comprises a first and a second flexible flap 28a, 28b for engaging the respective circular portion of the handle 23, as shown in FIG. 6.

Like the embodiments described above, a point P′ can be identified on the side 23a of the handle 23 facing the working line L′, close to the point where the user's thumb or index finger comes into contact with the toothbrush 22.

Another point A′ can be identified on the working line L′ close to the free ends of the bristles 27 nearest the handle 23.

It is thus possible to define the distance D′ between the points P′ and A′ and the height H′ separating the point P′ from the working line L′. Finally, the reference character C denotes the distance separating the point P′, as projected onto the working surface L′, from the point A′.

This electric toothbrush may have the same dimensions as the toothbrush embodiments described above. Specifically, in this embodiment, which is designed for a standard adult user, the distance D′ measures 5.5 cm and the height H 2.2 cm. The distance C measures 5.0 cm.

Further, the length S′ of the bristled portion of the roller that revolves about an axis parallel to the handle varies in a range of 0.5 cm to 2.0 cm.

In particular, for a child, the length S′ varies in a range of 0.5 to 1.3 cm, while for an adult, it varies preferably in a range of 0.7 to 1.5 cm.

The height of the bristles varies preferably in a range of 2 to 6 mm.

Inside the handle 23 there is a cavity (not illustrated in the drawings) designed to house the above mentioned motor means which preferably comprise an electric motor (not illustrated), transmission means (not illustrated) that connect the motor to the roller 26, between the inclined connecting portion 24 and batteries (not illustrated) used to power the motor.

A button 29 located on the surface 23a of the handle 23 facing the working line L′ is used to operate the toothbrush 22.

Whenever selected by the user, the electric motor imparts to the roller 26 a rotational motion in either a clockwise or an anticlockwise direction: that means the brushing action of the bristles 27 can be controlled so it is always from the gums to the ends of the teeth.

If necessary, the head 25 and the connecting portion 24 can be separated from the handle 23 so that they can be changed.

In yet another embodiment of the toothbrush, illustrated in FIG. 8, the head 34 with the bristles 35 is made directly on the extension of the connecting portion 33 and the face 34a of the head from which the bristles 35 extend is inclined at an angle to the handle 32 and to the surface 35a formed by the free ends of the bristles 35. As illustrated, in this embodiment, the bristles differ in height so as to form a working surface 35a which is parallel, or substantially parallel, to the handle axis X and which is also preferably such that its dimensions are similar to the preferred dimensions H, C and D indicated above for the other preferred embodiments.

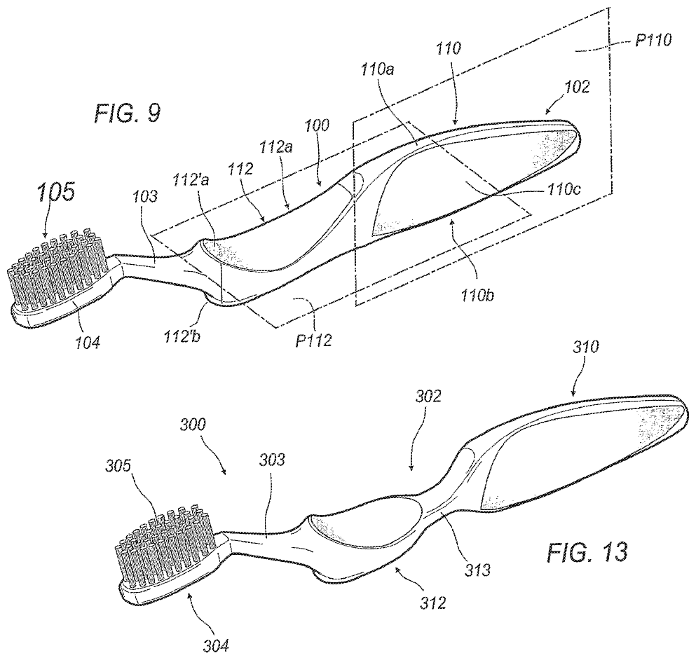

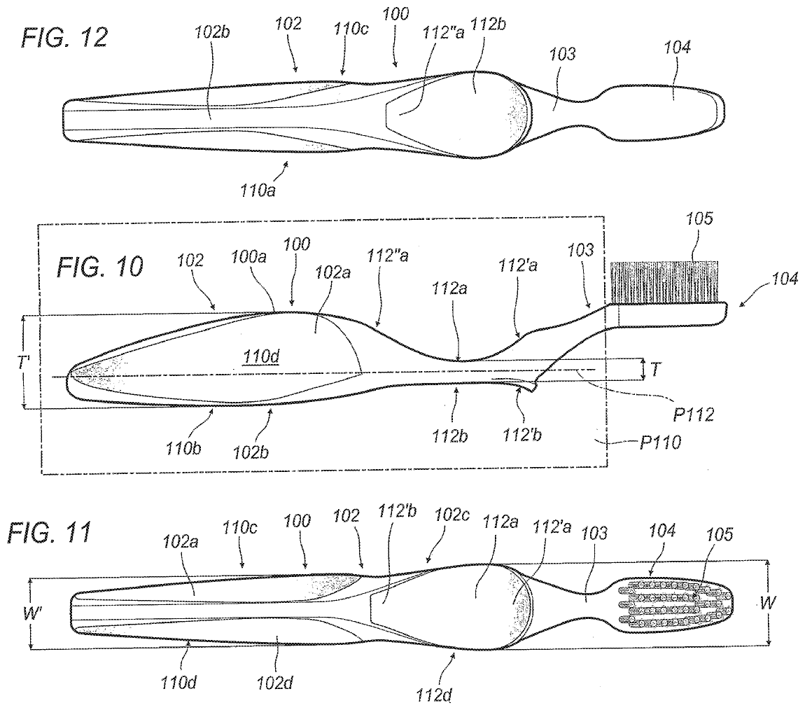

A sixth preferred embodiment of the toothbrush is illustrated in FIGS. 9 to 12.

This sixth embodiment of the toothbrush, denoted in its entirety by the numeral 100, comprises a handle 102, which in turn comprises an upper part 102a, on the side on which the bristles extend from the head 104, a lower part 102b, on the side opposite the one on which the bristles 105 extend from the head 104, and opposite side or lateral parts 102c, 102d.

As illustrated, like the other embodiments, between the toothbrush head 104 and the handle there is a connecting portion 103 that extends from the head or plate 104 in the direction opposite the direction in which the bristles 105 extend.

The handle 102 comprises an elongated portion 110, extending lengthways away from, or opposite to, the head 104 and around which the user's fingers can be wrapped, and an intermediate portion 112, extending between the elongated portion 110 and the working head 104 and constituting means on which at least one of the fingers, normally the users thumb or index finger, can be rested.

The drawings also show how the intermediate portion 112 extends in a transversal direction according to a mid plane P112 that is perpendicular to the mid plane P110 in which the elongated portion 110 extends.

Advantageously, the width W of the intermediate engagement portion 112 is greater than the width W of the elongated portion 110.

In this way, a wide and convenient rest is formed for the user's thumb or index finger, allowing an easier and more effective tooth brushing action, requiring less pressure and therefore less strain on the hand.

In particular, the intermediate engagement portion has a top surface 112a that faces upwards in the direction in which the bristles 105 extend, and an opposite engagement surface 112b that faces downwards in the opposite direction to that in which the bristles 105 extend, each of the portions 112a, 112b having, in the transversal direction, a generally planar form perpendicular to the handle's plane of symmetry, denoted by the reference label P110 in FIG. 9.

Further, the lower engagement surface 102b also has a substantially planar form in the longitudinal direction, whilst the upper engagement surface 112a has, in the longitudinal direction, is of upwardly concave arcuate form creating a convenient thumb rest that facilitates manipulation.

It will be understood, however that, although this embodiment is especially preferred, a handle is also imaginable wherein the lower engagement portion extends in longitudinally concave fashion in the same way as the upper engagement surface or, vice versa, wherein the upper engagement surface extends in a substantially linear longitudinal direction in the same way as the lower engagement surface.

Also, as illustrated, the sides of the intermediate portion 102, denoted by the reference labels 102c and 102d, are of arcuate form that is convex towards the outside of the handle 102.

This creates a wide portion that the user can conveniently and securely hold between two fingers.

According to another advantageous aspect, the handle 102 has an elongated portion 110 whose maximum height T′ is greater than the respective width W′.

According to yet another advantageous aspect, the handle 102 has an intermediate elongated portion 112 whose width W is greater than the respective height or thickness T.

As illustrated, the height T′ of the end portion 110 is greater than the height or thickness T of the intermediate engagement rest portion 112.

Specifically, the intermediate engagement portion 112 has a height or thickness T of between 3 mm and 7 mm and a width W of between 9 mm and 25 mm, whilst the elongated engagement portion 110 has a height or thickness T′ of between 17 mm and 39 mm and a width W of between 9 mm and 17 mm.

As illustrated, the intermediate portion 112 has an upper edge 112a of arcuate form which is concave in the upward direction, that is to say, in the direction in which the bristles extend.

Further, the lower edge 110b of the elongated portion 110 is substantially linear and aligned with the lower engagement portion 112b of the intermediate portion 112.

Also, as illustrated, the sides 110c, 110d of the elongated portion 110 have a rounded shape that is convex towards the outside of the handle 102.

This provides an end grip that is easy to hold securely between the fingers and palm of the hand so that the toothbrush does not perform unwanted rotations during the brushing action.

In practice, the elongated portion 110 around which the fingers can be wrapped extends in a direction perpendicular to the transversal direction in which the intermediate rest portion 112 extends.

As illustrated, the upper rest surface 112a has, on the side nearest the head 104, an upwardly extending part 112′a forming a surface for stopping the thumb or index finger and, on the opposite longitudinal side an upwardly extending transient portion 112″ a that blends into the upper edge 110a of the elongated portion 110.

The lower rest surface 112b in turn has, on the side facing the head 104, a downwardly extending part 112′b forming a surface for stopping one of the user's fingers, normally the index finger or thumb.

As illustrated, the stop surface 112′b of the lower engagement surface is substantially aligned, in the vertical or perpendicular direction, with the stop surface 112′a of the upper engagement portion 112a.

Further, the elongated portion 110a has, at the end furthest from the head 104, a tapered shape converging towards the tip.

A seventh preferred embodiment of the toothbrush is illustrated in FIG. 13.

This seventh preferred embodiment of the toothbrush, labelled 300 as a whole, comprises a handle 302 and, between the toothbrush head 304 and the grip portion of the handle, a connecting portion 303 that extends from the head 304 in the direction opposite to the direction in which the bristles 305 extend, in the same way as the other preferred embodiment already described.

The handle 302 comprises an elongated portion 310, extending lengthways away from, or opposite to, the head 304 and which can be wrapped between the fingers and palm of the users hand, and an intermediate portion 312, extending between the elongated portion 310 and the working head 304 and constituting means on which at least one of the users fingers can be rested, which can preferably be held between the users thumb and index finger.

Advantageously, the intermediate engagement portion 312 is joined to the elongated portion 310 by a flexible connection defined by a narrowing portion 313, whose diameter or width and, possibly also height, is less than that of the intermediate portion 312 and that of the elongated portion 310.

The handle of this toothbrush is made preferably of a flexible plastic material. This seventh preferred embodiment of the toothbrush, except for the flexible connection 313 between the handle portions 310 and 312, is similar in all other respect to the sixth preferred embodiment and, for brevity and convenience, will not be described in detail.

According to another aspect, the bristled heads 4, 104, 304, when viewed from above, have a rectangular or elliptic shape with a width of between 7 mm and 15 mm, preferably 14 mm, and a length of between 19 mm and 25 mm, preferably between 21 mm and 23 mm. Also, the thickness or height of the head is 4 or 5 mm.

The bristles on the head are preferably arranged in a plurality of parallel rows. Two to six rows are preferable. The arrangement with six rows is illustrated in FIG. 15, where the rows are labelled 051, 052, 053, 054, 055, 056. The numeral 04 in FIG. 15 denotes the head.

Advantageously, as illustrated, each row of bristles 051, 052, 053, 054, 055, 056 comprises elongated groups or tufts each comprising a plurality of bristles arranged in rectangular fashion with the long side extending in the longitudinal direction of the head. Each row of bristles comprises a plurality of groups, or tufts, 050, separated by a small space 07. Advantageously, the tufts are arranged in alternating fashion so that the tufts 050 of one row are aligned, in the transversal direction, with the separating spaces 07 of the adjacent row.

It is also imaginable that the bristles of the lateral rows 051, 052, 055, 056 are softer than those of the central rows 053, 054. Thus, when brushing the teeth according to the Bass method, the lateral rows come mainly into contact with the gums and the fact that they are softer prevents damage to the gums and instead produces a massaging action with an oxygenating effect on the gum tissue.

According to another imaginable arrangement, bristle rows 051, 052, 053, 054, 056, of different lengths in the longitudinal direction might be provided, where each row instead of being divided into groups or tufts like those shown in FIG. 15, is continuous, that is to say, does not have the bristle-free spaces shown in FIG. 15.

FIG. 15 also shows how, preferably, the bristles 06 on the connecting portion 03, similar to the connecting portions 3, 103, 203, 303 described above, might be arranged in a plurality of rows 061, 062, 063 extending transversally to the principal direction in which the head 04 extends. However, any other suitable arrangement for the bristles on the connecting portion might also be used.

As illustrated schematically in FIGS. 16A, 16B and 16C, the bristles may be arranged transversally in any desired configuration.

In particular, the bristles might be transversally arranged in a “hogback” configuration, as shown in FIG. 16A, where the working surface 05a of the bristles 05 has an upwardly convex shape, that is to say, convex in the direction in which the bristles extend from the head 04′, this form being especially suitable for brushing the teeth according to the Bass method. It will be understood that in a hogback configuration of this type, the preferred dimensions indicated above refer to the central area 05′ furthest away from the bristle mounting head.

Also, the bristles might be transversally arranged as shown in FIG. 16B, where their working surface 05a has an upwardly concave shape, that is to say, forms a curve whose concavity is in the direction in which the bristles extend from the head 04′. It will be understood that in this recessed configuration, the preferred dimensions indicated above refer to the lateral areas 05″, 05″ or to the bristle rows at the side, that is to say, to the bristles whose ends are furthest away from the bristle mounting head 04′.

The bristles might also be transversally arranged in such way as to form a flat surface 05a as in the toothbrush embodiments described above and as shown FIG. 16C where the reference characters used to denote the bristles 05 and the head 04′ are the same as those used in FIGS. 16A and 16B.

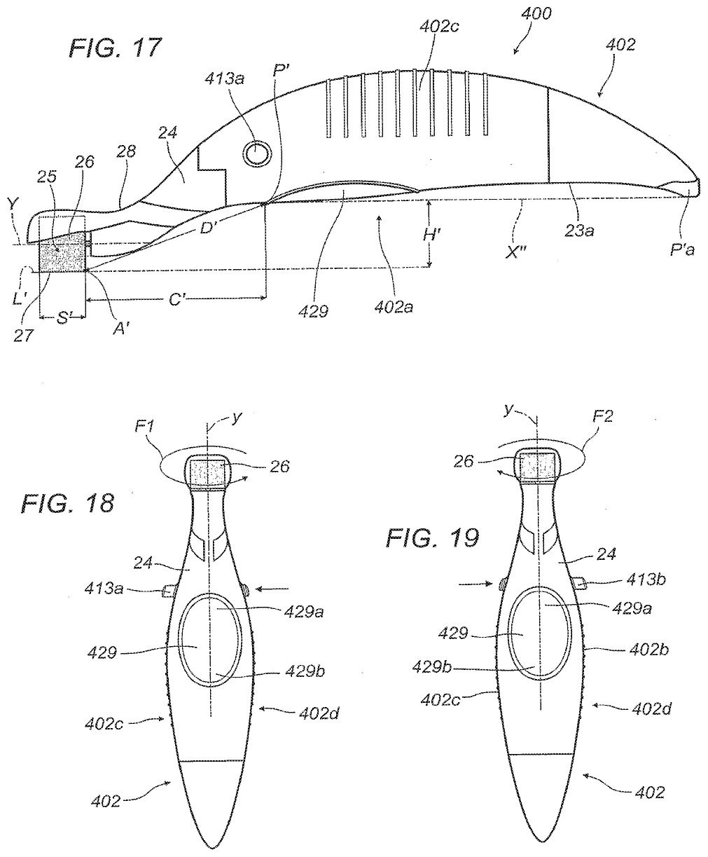

FIGS. 17 to 19 illustrate another toothbrush embodiment 400 constituting a second power-driven embodiment of the toothbrush according to the invention. The characteristics of this embodiment are substantially the same as those of the toothbrush of FIG. 6, these characteristics being denoted by the same numeric references and not described again in detail.

This second power-driven embodiment of the toothbrush comprises a first pushbutton to select rotation of the bristle head in one direction and a second pushbutton to select rotation of the bristle head 26 in the opposite direction.

These pushbutton control means consist of a first and a second pushbutton 413a, 413b mounted on opposite lateral or side faces 402c, 402d of the handle. They can be pressed alternately to cause the bristle head 26 to turn in the direction indicated by the arrow FI in FIG. 18 or in the opposite direction, indicated by the arrow F2 in FIG. 19.

This second power-driven embodiment of the toothbrush comprises another pushbutton 429 to start the bristle head turning in a default direction, that is to say, in the direction previously selected using pushbutton 413a or 413b.

The pushbutton control 429 is mounted on the face 402a on the same side as the head and comprises a first end 429a that can be pressed to start the head and a second end 429b that can be pressed to stop the head.

Thus provided is a toothbrush that is effective and easy to use and is particularly suitable for brushing the teeth according to the Bass method, a tooth brushing method well known in the trade.

This toothbrush and in particular the handle of the toothbrush is made of a plastic material, preferably a flexible plastic material.

The invention described has evident industrial applications and can be modified and adapted without thereby departing from the scope of the inventive concept. Moreover, all details of the invention may be substituted by technically equivalent elements.

1-74. (canceled)

75. A toothbrush for an adult user brushing a teeth and gum margin according to the Bass method, comprising:
a handle having a length;
a head having a length and a width, the length of the head being greater than the width of the head, the head having a principal longitudinal axis of extension which extends longitudinally to the handle along a length direction of the handle;
a plurality of bristles attached to a lower face of the head, wherein ends of the bristles form a working surface extending longitudinally along a working line for the toothbrush, the bristles extending from the face of the head in a downward first direction;
an inclined connecting portion located between the handle and the head, wherein the handle and the connecting portion extend from the head in an upward second direction opposite to the downward first direction of the bristles,
wherein,
a finger rest is located on a lower side of the handle, the finger rest beginning adjacent a point where the handle joins the connecting portion, on which finger rest a user can engage a finger when holding the handle,
a raised portion is positioned between the finger rest and the connecting portion, the raised portion extending in the downward first direction to provide a height differential between the raised portion and the finger rest which defines a stop between the finger rest and the connecting portion to prevent the users finger from moving from the finger rest onto the connecting portion,
the working line formed by the bristles extends longitudinally in a direction parallel to the principal longitudinal axis of the handle,
a height between
i) the point where the handle joins the connecting portion and
ii) the working line of the toothbrush being in a range of 1.7 cm to 3.5 cm,
a distance between one end point of the finger rest and a point, defined by free ends of the bristles nearest the finger rest, is in a range of 4.6 cm to 5.8 cm,
wherein the length of the working surface of the bristles is in a range of 1.8 cm to 2.3 cm,
so that the Bass technique can be optimally applied along the whole dental arch;
wherein the handle comprises an elongated portion which extends lengthways away from the head and which is configured to be gripped by the users fingers, and an intermediate engagement portion, located between the elongated portion and the working head, on which at least one of the users fingers can be rested, where the width of the intermediate engagement portion is greater than the width of the elongated portion;
where the intermediate engagement portion comprises first and second, upper and lower, opposite engagement surfaces on which respective fingers can be rested by the user;
wherein a height of the elongated portion is greater than a height of the intermediate engagement portion.

76. The toothbrush according to claim 75, wherein the connecting portion extends in a linear or substantially linear direction and has an upper surface that is linear or substantially linear in the direction of the bristles.

77. The toothbrush according to claim 75, wherein the height between the point where the handle joins the connecting portion and the working line of the toothbrush is in a range of 1.7 cm to 2.8 cm.

78. The toothbrush according to claim 75, wherein, the distance measures 4.6 cm and the height 1.7 cm.

79. The toothbrush according to claim 75, wherein, the distance measures 4.8 cm and the height 2.2 cm.

80. The toothbrush according to claim 75, wherein, the distance measures 5.4 cm and the height 1.7 cm.

81. The toothbrush according to claim 75, wherein, the distance measures 5.5 cm and the height 2.2 cm.

82. The toothbrush according to claim 75, wherein, the distance measures 5.8 cm and the height 2.8 cm.

83. The toothbrush according to claim 75, wherein the head extends along a principal longitudinal axis that is parallel or substantially parallel to the principal longitudinal axis of the handle.

84. The toothbrush according to claim 75, wherein the connecting portion extends in a linear or substantially linear direction and has an upper surface that is concave in the direction of the bristles.
